(19) United States
(12) Patent Application Publication
(10) Pub. No.: US 2022/0041003 A1
(43) Pub. Date: Feb. 10, 2022

(54) Multi-Purpose Paper Holder

(71) Applicant: Steven Brian Williams, Elon, NC (US)

(72) Inventor: Steven Brian Williams, Elon, NC (US)

(21) Appl. No.: 16/986,593

(22) Filed: Aug. 6, 2020

(51) Int. Cl. B42D 17/00; B43M 9/00

(52) U.S. Cl. CPC B42D 17/00; B43M 9/00

(57) ABSTRACT

A multipurpose paper holder is configured to hold paper articles against a vertical support surface. The multipurpose paper holder comprises a base configured to be mounted to a vertical surface, an arm pivotally connected to the base and configured to rotate towards the vertical support under gravitational force, and a pressure pad attached to a lower end of the arm for pressing the paper article against the vertical support surface.

### TECHNICAL FIELD

The present disclosure relates generally to paper holders for holding papers against a vertical surface such as a wall and, more particularly, to a multipurpose paper holder with a hook or hanger for hanging various articles such as coats, hats, purses, keys, etc.

### BACKGROUND

Various devices are used in the home to post notes, reminders, letters or the like in a place where they will be readily seen and not forgotten. One common example is a corkboard used to pin notes, photographs and other papers. Magnetic boards can be used in a similar manner, or magnets can be used to post papers to a refrigerator door, for example. Whiteboards and chalkboards can also be used to leave notes that can be subsequently erased. Each of these cases requires use of pins, magnets, chalk, markers or other items that can be lost or misplaced and therefore not available when needed. Accordingly, there is a need for a tool to post papers where they can be readily seen and that does not require separable items that can be lost.

### SUMMARY

The present disclosure relates generally to a multipurpose paper holder configured to hold paper articles against a vertical support surface. In one exemplary embodiment, the multipurpose paper holder comprises a base configured to be mounted to a vertical surface, an arm pivotally connected to the base and configured to rotate towards the vertical support under gravitational force, and a pressure pad attached to a lower end of the arm for pressing the paper article against the vertical support surface.

some embodiments of the multipurpose paper holder further include a hook extending outward from the arm is provided for hanging personal items such as coats, hats, purses, keys, etc. In some embodiments, the hook extends from the arm in a direction away from the vertical support surface. The hook may include a decorative element, such as an emblem or coin.

In some embodiments, the arm comprises an upper arm and a lower arm joined to form an elbow. The lower arm in one embodiment extends generally horizontally and provides a support for engagement by a hanger, such as a coat hanger. In embodiments with a hook, the hook is adjacent the elbow and extends outwardly from the arm in a direction away from the vertical support surface

In some embodiments, the pressure pad comprises a cylindrical weight attached at a lower end of the arm.

Some embodiments of the paper holder further comprise a biasing member for urging the pressure pad towards the vertical support surface. the biasing member may, for example, comprise a spring.

The multipurpose paper holder of claim 1 further comprising a strap for securing the base to a vertical column or pole.

### BRIEF DESCRIPTION OF THE DRAWINGS

FIG. 1 is a perspective view of a multipurpose paper holder according to one exemplary embodiment configured to mount to a flat surface.

FIG. 2 is an elevation view of the multipurpose paper holder.

FIG. 3 is a perspective view of a multipurpose paper holder as shown in FIG. 1 mounted next to a door on the exterior of a house.

FIG. 4 is an elevation view of the multipurpose paper holder including a hook.

FIG. 5A is a front view of a multipurpose paper holder including a decorative hook.

FIG. 5B is a perspective view of a multipurpose paper holder including a decorative hook.

FIG. 6 is a perspective view of a multipurpose paper holder including a spring-loaded pressure pad.

FIG. 7 is a perspective view of a multipurpose paper holder configured to mount to a pole or column.

FIG. 8 is a perspective view of a multipurpose paper holder as shown in FIG. 6 mounted to a pole or column.

### DETAILED DESCRIPTION

Referring now to the drawings, exemplary embodiments of a multi-purpose paper holder 10 are shown. For convenience, similar reference numbers of used throughout the drawings to indicates similar parts.

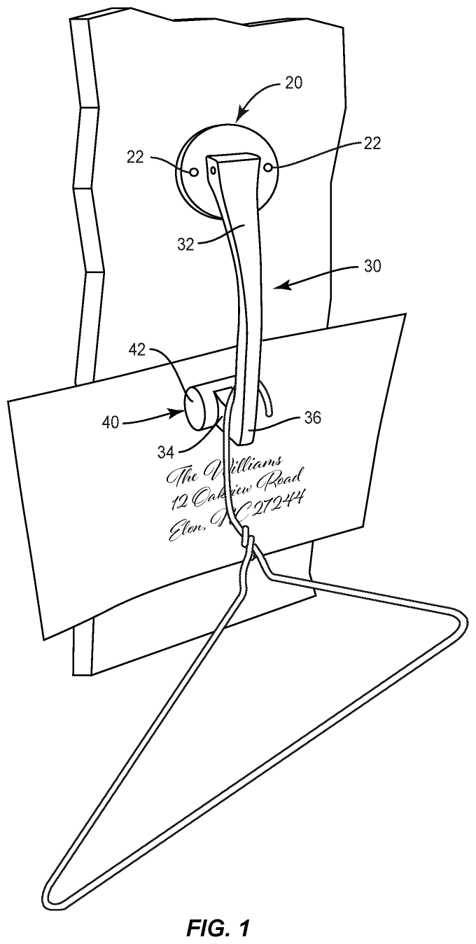

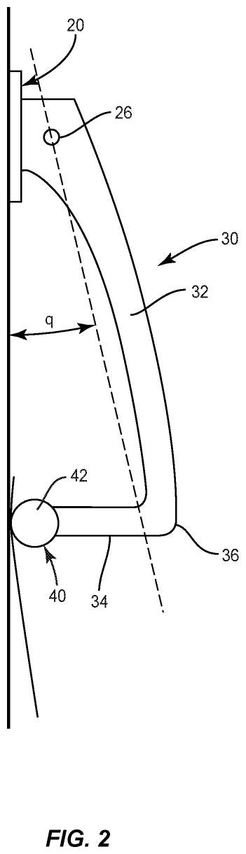

Referring to FIGS. 1 and 2, the multi-purpose paper holder 10 generally comprises a base 20 configured to mount to a vertical support surface, an arm 30 pivotally connected to the base, and a pressure pad disposed at a lower end of the arm 40 for pressing a paper article against the vertical support surface to hold the paper article in place. In some embodiments, the multi-purpose paper holder 10 may further include a hook for hanging articles such as hats, coats, purses, keys, etc.

The base 20 comprises a metal plate with a back surface configured to conform to a vertical support surface, such as a wall, column or pole. In some embodiments, the back surface of the base 20 is configured to mount against a flat surface, such as a wall. In other embodiments, the base 20 may be configured to mount against a circular column or pole, or other curved surface. In some embodiments, the mounting plate 22 may include mounting holes 24 through which screws or other fasteners extend to mount the base 20 to the vertical support surface. In other embodiments, the base 20 may mount to a bracket (not shown) that is fastened to the wall by screws or other fasteners.

As seen best in FIG. 2, the arm 30 includes an upper arm 32 and lower arm 34 joined at an elbow 36. The upper arm 32 pivotally attaches at its upper end to the post 22 on the base 20 so as to rotate about a pivot pin 26. The lower arm 34 extends generally horizontally from the lower end of the upper arm 32 and joins the upper arm 32 at the elbow 36. The lower arm 34 provides a support that can be engaged by hangers, such as clothes hangers or the like, as shown in FIG. 1.

The pressure pad 40 attaches to the free end of the lower arm. In the embodiment shown in FIG. 1, the pressure pad 40 comprises a cylindrical member 42 with an axis that extends parallel to a flat vertical support surface (or tangentially relative to a curved support surface). In use, the curved outer of the cylindrical body 42 contacts a paper article placed in the holder and presses the paper article against the vertical support surface.

The arm 30 is configured so that the pressure pad 40 is forced by gravity into contact with the vertical support surface. This means that a line drawn between the axis of rotation and center of gravity (CG) of the arm 30 is disposed at an angle ⊖ relative to the vertical support surface when the pressure pad is in contact with the vertical support surface.

In use, a letter, note, or other paper article can be slid between the pressure pad 40 and the vertical support surface as shown in FIGS. 1 and 2. The paper holder 10 can hold multiple paper articles. In the embodiment shown in FIGS. 1 and 2, the curved outer surface of the pressure pad 40 allows the paper article to be slid between the pressure pad 40 and the vertical support surface without having to use a hand to lift arm 30. This feature enables paper articles to be inserted into the holder in a “handsfree” manner without releasing or dropping paper articles already in the paper holder 10. Similarly, paper articles can be removed by simply pulling the paper article without having to use a hand to lift the arm 30. If multiple items are being held by the paper article, a single item can be removed without releasing the other items being held by the paper holder 10.

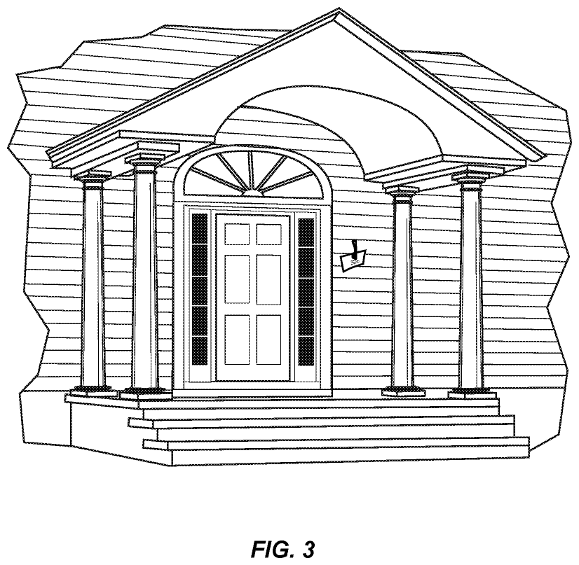

The multi-purpose paper holder 10 in FIG. 1 can be mounted to a wall adjacent a doorway where the paper article will be readily seen when entering or exiting a building through the doorway. When mounted on an interior wall adjacent a doorway as shown in FIG. 3, the paper holder 10 can be used to hold notes, reminders or other papers that require attention when a person is leaving their home. When used on an exterior wall, the paper holder 10 can be used to hold letters, advertising flyers and the like. If a person uses a dry cleaning service that makes home deliveries, the dry cleaning service can hang the clothing articles being returned on the lower arm of the paper holder. The paper holder 10 could also be mounted to a mailbox post to provide a convenient way for others to leave advertising flyers or solicitations.

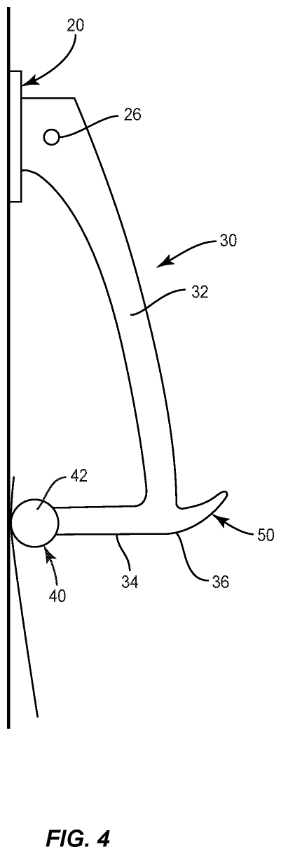

In the embodiment shown in FIG. 3, the paper holder 10 includes a hook 50 for hanging coats, hats, purses, keys or other personal items. The hook 50 is disposed at the lower end of the upper arm 32 adjacent the elbow 36 and extends outwardly from the arm 30 in a direction away from the vertical support surface. In some embodiments, the hook 50 may comprise a plain, unadorned hook. In other embodiments, the hook 50 may comprise a decorative element that also functions as a hook as shown in FIGS. 4A and 4B. In some embodiments, the decorative element may be removable so that different decorative elements can be interchanged over time.

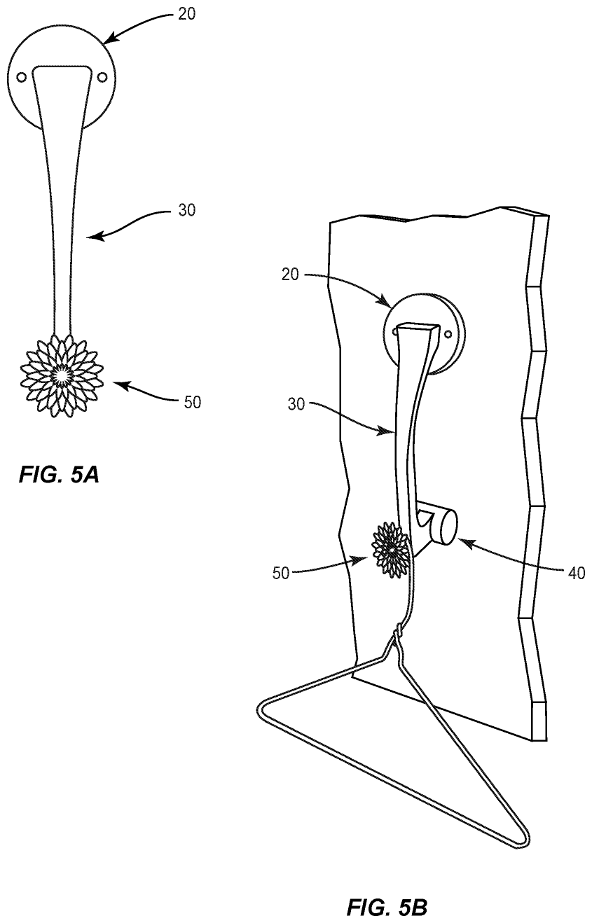

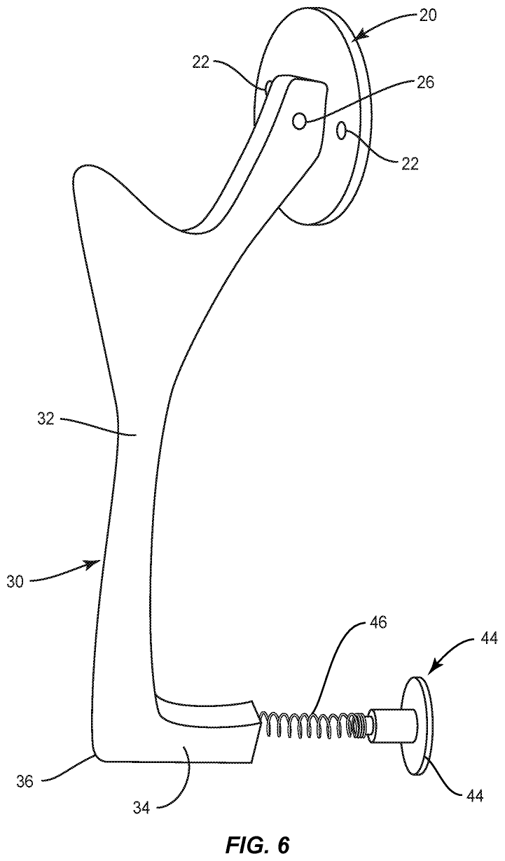

FIG. 5 illustrates an alternate embodiment of the paper holder 10. the paper holder 10 includes a base 20, arm 30 and a pressure pad 40 as previously described. In this embodiment, the pressure pad 40 comprises an elastic footpad 44 that is biased by a spring 46. The spring 46 urges the pressure pad 40 towards the vertical support surface. the spring 46 comprises a conventional compression coil spring, but other types of springs or biasing members could be used in place of the compression coil spring.

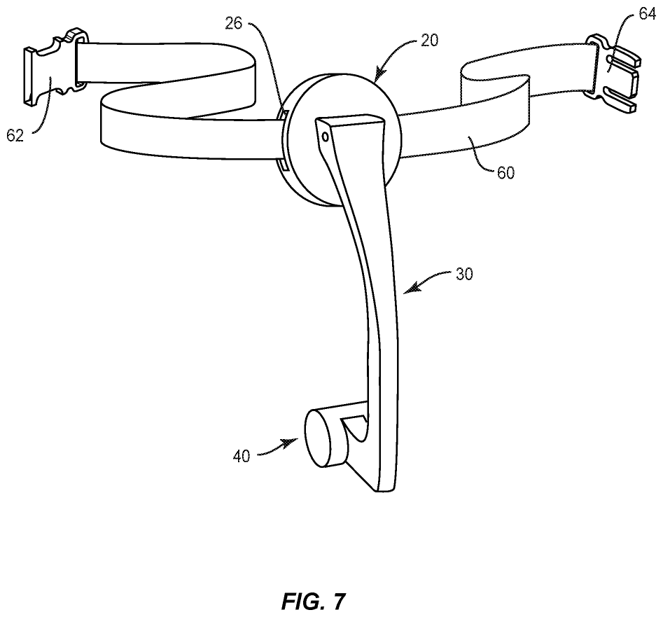

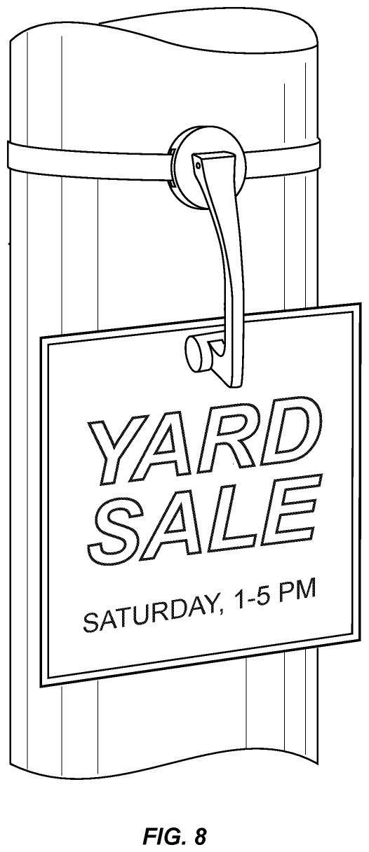

FIGS. 7 and 8 illustrate an embodiment of the multi-purpose paper holder 10 that is designed to mount to a telephone pole or the like. In this case, the back surface of the base preferably includes curved surfaces to conform more closely to the outer surface of the pole. The base 20 can be provided with a slot 26 through which a strap 60 extends. The strap 60 can extend around the telephone pole and be provided with male and female buckles 62, 64 at opposite ends thereof for fastening the paper holder 10 to the telephone pole. In this example, the paper holder 10 can be used to post notices for garage sales, open house events, or the like. When the events are over, the paper holder can dismounted and reused at a later time.

What is claimed is:

1. A multipurpose paper holder comprising:
a base configured to be mounted to a vertical surface;
an arm pivotally connected to the base and configured to rotate towards the vertical support under gravitational force;
a pressure pad attached to a lower end of the arm for contacting a paper article and pressing the paper article against the vertical support surface; and
a hook extending outward from the arm for hanging a personal item.

2. The multipurpose paper holder of claim 1 wherein the arm comprises an upper arm and a lower arm joined to form an elbow, and wherein the hook extends from the arm adjacent the elbow.

3. The multipurpose paper holder of claim 1 wherein the hook extends from the arm in a direction away from the vertical support surface.

4. The multipurpose paper holder of claim 1 wherein the hook includes a decorative feature.

5. The multipurpose paper holder of claim 1 wherein the pressure pad comprises a cylindrical weight attached at a lower end of the arm.

6. The multipurpose paper holder of claim 1 further comprising a biasing member for urging the pressure pad towards the vertical support surface.

7. The multipurpose paper holder of claim 5 wherein the biasing member comprises a spring.

8. The multipurpose paper holder of claim 1 further comprising a strap for securing the base to a vertical column or pole.

9. A multipurpose paper holder comprising:
a base configured to be mounted to a vertical surface;
an arm pivotally connected to the base and configured to rotate towards the vertical support under gravitational force, the arm comprising:
an upper arm pivotally connected at an upper end to the base;
a lower arm connected to a lower end of the upper arm to form an elbow, the lower arm extending generally horizontally from the elbow towards the vertical support surface to form a support for engagement by a hanger; and
a pressure pad attached to a lower end of the arm for contacting a paper article and pressing the paper article against the vertical support surface.

10. The multipurpose paper holder of claim 9 further comprising a hook extending outward from the arm for hanging a personal item:

11. The multipurpose paper holder of claim 10 wherein the hook extends from the arm in a direction away from the vertical support surface.

12. The multipurpose paper holder of claim 10 wherein the hook includes a decorative feature.

13. The multipurpose paper holder of claim 9 wherein the pressure pad comprises a cylindrical weight attached at a lower end of the arm.

14. The multipurpose paper holder of claim 9 further comprising a biasing member for urging the pressure pad towards the vertical support surface.

15. The multipurpose paper holder of claim 14 wherein the biasing member comprises a spring.

16. The multipurpose paper holder of claim 9 further comprising a strap for securing the base to a vertical column or pole.
